(19) United States
(12) Patent Application Publication
(10) Pub. No.: US 2012/0041577 A1
(43) Pub. Date: Feb. 16, 2012

(54) REFRIGERATOR AND CONTROL METHOD THEREOF

(75) Inventors: Sung Ho CHO, Gwangju (KR); Chang Hern LEE, Gwangju (KR); Jae Won LEE, Gwangju (KR)

(73) Assignee: SAMSUNG ELECTRONICS CO., LTD., Suwon-si (KR)

(21) Appl. No.: 13/206,849

(22) Filed: Aug. 10, 2011

(30) Foreign Application Priority Data
Aug. 11, 2010 (KR) 10-2010-0077258

(51) Int. Cl. G05D 23/19; G06F 17/30

(52) U.S. Cl. 700/90; 707/769; 707/E17.014

(57) ABSTRACT

A refrigerator to control food storage conditions and a control method thereof include controlling temperature in the refrigerator. The control method includes determining whether time data to be used to confirm a season is stored in a storage unit, requesting a user to input time data upon determining that the time data is not stored in the storage unit, and determining whether the stored time data is to be changed upon determining that the time data is stored in the storage unit. Temperature in the refrigerator is controlled based on properties of food for each season to improve storage efficiency of food.

### CROSS-REFERENCE TO RELATED APPLICATIONS

This application claims the priority benefit of Korean Patent Application No. 2010-0077258, filed on Aug. 11, 2010 in the Korean Intellectual Property Office, the disclosure of which is incorporated herein by reference.

### BACKGROUND

1. Field

Embodiments relate to a refrigerator to control food storage conditions and a control method thereof.

2. Description of the Related Art

A refrigerator keeps food fresh for a long time irrespective of season for user convenience. That is, the refrigerator prevents food from rotting, freezing or decaying due to temperature change depending upon season. However, the same food may have different moisture contents and salt contents depending upon season. Therefore, the food may not be equally maintained even when the food is stored at the same temperature. Kimchi may be largely classified as seasonal Kimchi and winter Kimchi. Winter Kimchi has a high salt content for long term storage. Seasonal Kimchi has different moisture contents and fibroid material properties depending upon when Chinese cabbages are grown. If Kimchi is stored at the same temperature irrespective of season, the refrigerator may not correctly reflect a change in Kimchi depending upon season due to differences in properties of Kimchi, with the result that Kimchi may not be stored while maintaining the tastes of Kimchi based on season.

A conventional refrigerator stores food at fixed temperature irrespective of season. However, the refrigerator may not properly maintain the taste of food stored therein.

Also, in the conventional refrigerator, a reference ON value temperature to drive a compressor and a reference OFF value temperature to stop the compressor are preset. Therefore in the conventional refrigerator, whether the compressor is to be driven is decided based on temperature in the refrigerator with the result that the refrigerator may not flexibly cope with seasonal temperature change. Operating temperature of the conventional refrigerator is fixed irrespective of season with the result that the refrigerator is not properly operated according to temperature of external air. Also, it may be necessary for a user to manually set operating temperature of the refrigerator.

### SUMMARY

It is an aspect to provide a refrigerator wherein temperature in the refrigerator is changed based on season to efficiently store food and a control method thereof.

Additional aspects will be set forth in part in the description which follows and, in part, will be apparent from the description, or may be learned by practice of the invention.

In accordance with an aspect, a control method of a refrigerator includes determining whether time data to be used to confirm a season is stored in a storage unit, requesting an external source, such as a user, to input time data upon determining that the time data is not stored in the storage unit, and determining whether the stored time data is to be changed upon determining that the time data is stored in the storage unit.

Requesting the user to input time data may include requesting the user to input time data through display on a display unit or sound.

The control method may further include deciding the input time data as reference time data when the time data is input by the user.

The control method may further include deciding default time data as reference time data after a predetermined time elapses when the time data is not input by the user.

The control method may further include comparing temperature in the refrigerator with a reference temperature to decide reference time data when the time data is stored in the storage unit.

The control method may further include requesting the user to input time data when the temperature in the refrigerator is equal to or greater than the reference temperature.

The control method may further include deciding the input time data as the reference time data when the time data is input by the user.

The control method may further include deciding time data stored in the storage unit as the reference time when the temperature in the refrigerator is less than the reference temperature.

The control method may further include confirming a season based on the decided reference time data.

The control method may further include controlling the refrigerator based on the decided reference time data, wherein controlling the refrigerator based on the decided reference time data may include controlling storage temperature in the refrigerator.

Comparing the temperature in the refrigerator with the reference temperature to decide the reference time data may include determining whether the time data stored in the storage unit corresponds to a season.

The storage unit may be nonvolatile.

The storage unit may include an EEPROM.

The storage unit may store a database of food storage temperatures based on the time data to be used to confirm the season.

The time data to be used to confirm the season may include months, months and days, or years, months and days.

Requesting the user to input time data through display on the display unit or sound may include requesting the user to input time data through seven segment blinks on the display unit.

In accordance with another aspect, a refrigerator includes a storage unit to store time data to be used to confirm a season and a controller to request a user to input time data upon determining that the time data is not stored in the storage unit and to determine whether the stored time data is to be changed upon determining that the time data is stored in the storage unit.

The refrigerator may further include a display unit to indicate whether the time data is stored in the storage unit and to display the time data.

The display unit may display the time data in seven segments.

The refrigerator may further include a manipulation unit to allow the user to input the time data.

The storage unit may store a database of food storage temperatures based on the time data to be used to confirm the season.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a sectional view illustrating the structure of a refrigerator according to an embodiment;

FIGS. 2A to 2C are plan views illustrating a display unit and a manipulation unit of the refrigerator according to the embodiment;

FIG. 3 is a block diagram illustrating the refrigerator according to the embodiment;

and

FIG. 4 is a flow chart illustrating the operation of the refrigerator according to the embodiment.

### DETAILED DESCRIPTION

Reference will now be made in detail to the embodiments, examples of which are illustrated in the accompanying drawings, wherein like reference numerals refer to like elements throughout.

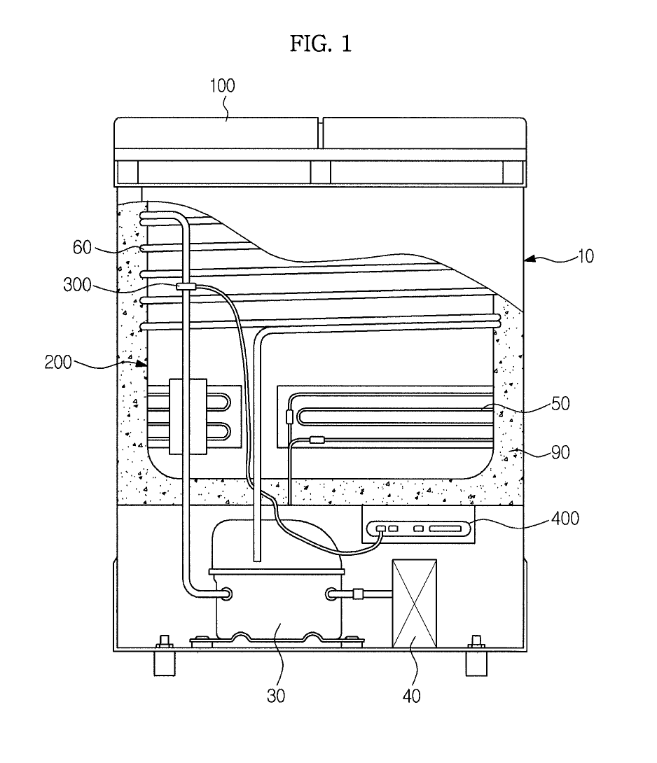

FIG. 1 is a sectional view illustrating the structure of a refrigerator according to an embodiment.

Hereinafter, a Kimchi refrigerator will be described as an embodiment. However, embodiments may be applied to a top mount type refrigerator, which has a freezing chamber disposed at the upper side thereof, a side by side type refrigerator, which has a refrigerating chamber and a freezing chamber disposed at the left and right sides thereof, and a three door bottom freezer type refrigerator.

The Kimchi refrigerator has a door 100 to open and close one side of a refrigerator body 10 so that Kimchi may be stored in a storage container 20 through the side of the refrigerator. The refrigerator body 10 includes a cooling apparatus to lower the temperature of the storage container 20. The cooling apparatus includes a compressor 30 to compress a refrigerant into a high-temperature, high-pressure gas state, a condenser 40 to perform heat exchange between the refrigerant from the compressor 30 and ambient air to cool the refrigerant, and an evaporator pipe 60 to change the refrigerant from the condenser 40 into a low-temperature, low-pressure state to lower the temperature of the storage container 20. Adjacent to the evaporator pipe 60 is a temperature detection unit 300 to detect the temperature of the storage container 20. Also, a heat insulation material 90 is provided around the storage container 20 to fill the interior of the refrigerator body 10 while surrounding the storage container 20.

The refrigerator body 10 of the Kimchi refrigerator also includes a heater 50, as a heating apparatus, to increase the temperature of the storage container 20. Also, the Kimchi refrigerator further includes a controller 400 provided in the refrigerator body 10. The controller 400 controls the operation of the Kimchi refrigerator so that the Kimchi refrigerator is operated according to conditions set externally to the Kimchi refrigerator, for example, by a user. Further, the controller 400 controls the heating apparatus or the cooling apparatus based on the temperature detected by the temperature detection unit 300.

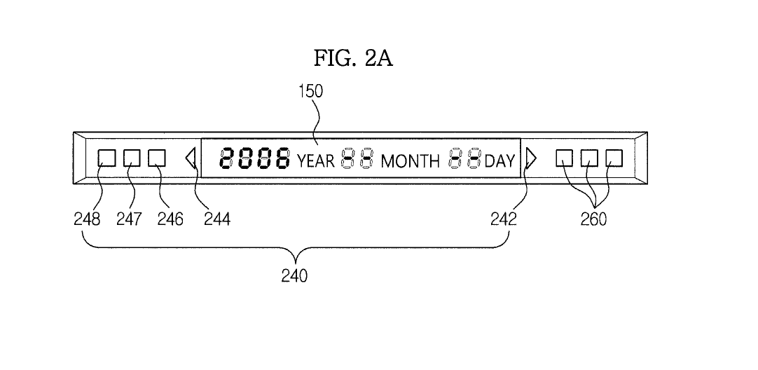

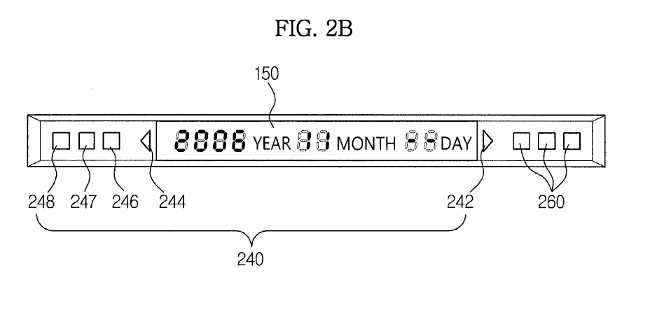

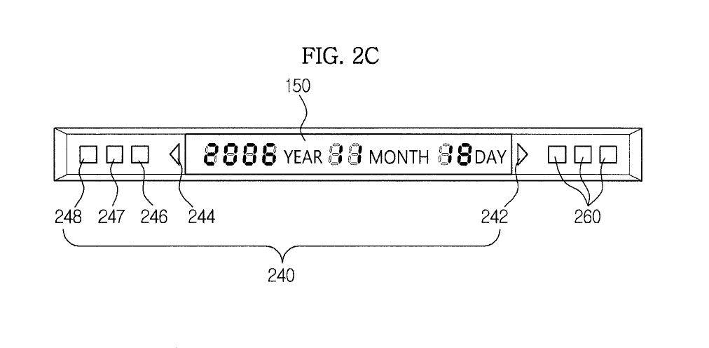

Although not shown in FIG. 1, a display unit 150 and a manipulation unit 200 (shown in FIGS. 2A, 2B, and 2C) are included at the front or the upper side of the Kimchi refrigerator. The display unit 150 may be a cathode ray tube (CRT), a liquid crystal display (LCD) or a light emitting diode (LED), for example, or any combination thereof. The manipulation unit 200 may be a button, a key, a dial or the like. Also, as shown in FIGS. 2A, 2B, and 2C, the display unit 150 and the manipulation unit 200 may be integrated. Alternatively, the display unit 150 and the manipulation unit 200 may be separately provided.

As described above, the Kimchi refrigerator includes the cooling apparatus and the heating apparatus. When a user, for example, selects a fermentation mode or a ripening mode, then the heater is driven to ferment Kimchi stored in the storage container, and then the cooling apparatus is driven to uniformly maintain the temperature of the storage container 20 (for example, approximately −2° C. to 0° C. for Kimchi storage), thereby preserving taste and freshness of Kimchi for a long time. In this way, the Kimchi refrigerator stores Kimchi stored in the storage container based on the selected mode and, when the temperature detected by the temperature detection unit 300 deviates from a reference temperature, the heating apparatus or the cooling apparatus is driven to uniformly maintain the temperature of the storage container 20.

In the examples of FIGS. 2A, 2B, and 2C, 3, and 4, the refrigerator requests data input from a user. However, the refrigerator may also, or alternatively, request data input from other external sources, such as through a wired or a wireless network.

FIG. 2A is a plan view illustrating a display unit and a manipulation unit of the refrigerator according to the embodiment.

The display unit 150 displays years, months and days. Years, months and days may be displayed in seven segments, for example. When months and days are not stored in a storage unit 500 or have not been input by a user (for example), months and days may blink as shown in FIG. 2A. Months and days may be displayed in other forms.

The manipulation unit 200 includes a date input unit 240 and a manipulator 260. The date input unit 240 includes several buttons. Specifically, the date input unit 240 includes a date input button 246 to select years, months and days in stages to input a date displayed in the display unit 150 and up/down buttons 242 and 244 to increase and decrease numbers displayed at the step selected by the date input button 246. Also, the date input unit 240 further includes a memory button 248 to set and store the date using the date input button 246 and the up/down buttons 242 and 244 and a reset button 247 to reset the date stored by the memory button 248. Also, the manipulator 260 may includes a temperature manipulation unit, storage mode setting unit or the like, or any combination thereof.

As shown in FIG. 2A, a year display section blinks, and a user increases or decreases numbers displayed on the display unit 150 using the up/down buttons 242 and 244 to set a desired year (2006 in FIG. 2A).

FIGS. 2B and 2C are plan views illustrating months and days input to the Kimchi refrigerator, for example, by a user. When the desired year is displayed as shown in FIG. 2A, the user presses the date input button 246 once again with the result that a month display section blinks. In this state, the user increases or decreases numbers displayed on the display unit 150 using the up/down buttons 242 and 244 to set a desired month (11 in FIG. 2B). Subsequently, the user presses the date input button 246 once again and increases or decreases numbers displayed on the display unit 150 using the up/down buttons 242 and 244 to set a desired day (16 in FIG. 2C). When a desired date (Nov. 16, 2006) is set, the user presses the memory button 248 to store the set date in the storage unit 500. When the user presses the date input button 246, the set date is displayed on the display unit 150, and a time count circuit provided in the display unit 150 is driven to count time.

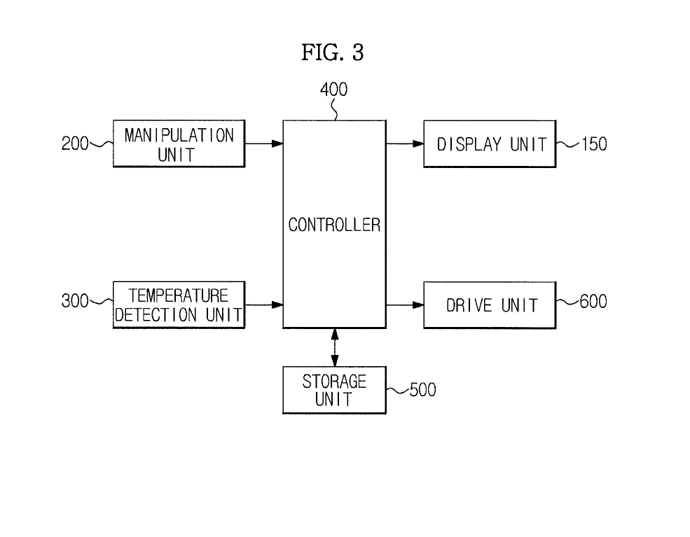

FIG. 3 is a block diagram illustrating the refrigerator according to the embodiment.

The refrigerator includes a display unit 150, a manipulation unit 200, a temperature detection unit 300, a controller 400, a storage unit 500 and a drive unit 600.

The display unit 150 displays a storage temperature, a storage mode, an amount of stored food in addition to the date shown in FIGS. 2A to 2C displayed according to a signal from the controller 400.

The manipulation unit 200 allows a user to input a storage temperature, a storage time and a storage mode. The manipulation unit 200 transmits an input signal to the controller 400. For example, a seasonal Kimchi selection button and a winter Kimchi selection button are separately provided for Kimchi. When one of the buttons is pressed by the user, therefore, Kimchi may be stored in the state selected by the user without additional input of time data irrespective of the control process described above.

The controller 400 requests the user to input time data or determines default time data as reference time data based on the user selection, or performs control corresponding to the button manipulated by the user selection at the manipulation unit 200.

The temperature detection unit 300 detects the temperature of the refrigerator. The temperature detection unit 300 transmits the detected temperature to the controller 400. The temperature detection unit 300 may detect temperature of air in the refrigerator or inside of the refrigerator. Also, one or more temperature detection units 300 may be provided in the refrigerator to more accurately detect temperature.

The storage unit 500 stores a signal from the manipulation unit 200 or the temperature detection unit 300 under control of the controller 400. The controller 400 reads data stored in the storage unit 500. The storage unit 500 may be nonvolatile. Also, the storage unit 500 may be a ROM, EPROM or EEPROM.

The drive unit 600 drives or stops the compressor 30 of the refrigerator according to a signal from the controller 400.

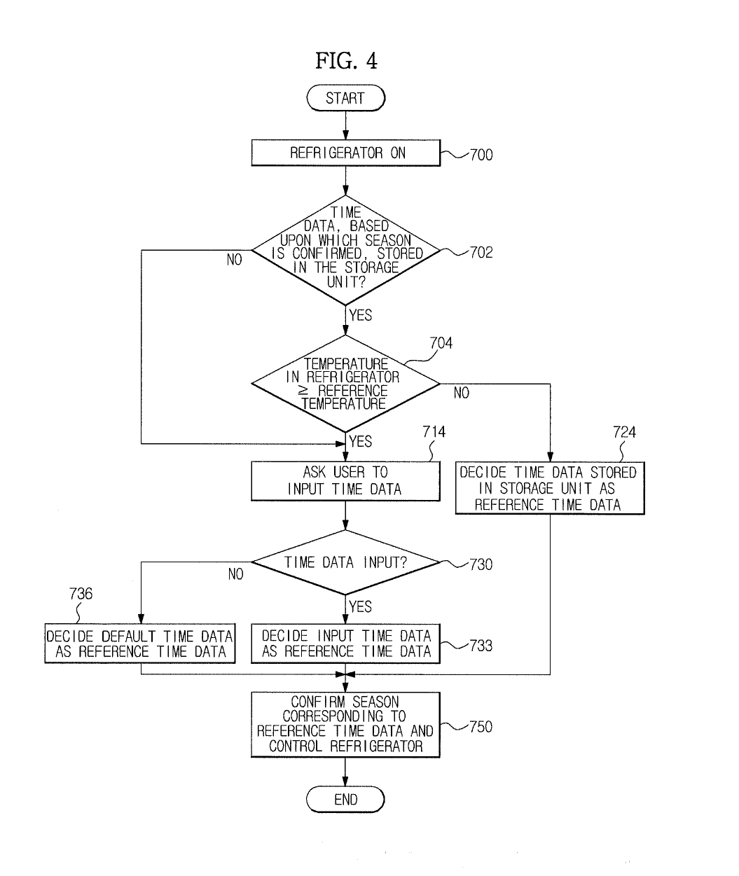

FIG. 4 is a flow chart illustrating the operation of the refrigerator according to the embodiment.

In FIG. 4, season is used as an example period of time. However, any predetermined period of time may be used.

When the refrigerator is turned on (700), the controller 400 determines whether time data, based upon which a season is confirmed, is stored in the storage unit 500 (702). The time data may be months or months and days. For example, July 15 indicates summer, and December 3 indicates winter.

When it is determined that the time data is not stored in the storage unit 500, the controller 400 requests an external source, such as a user, to input new time data (714).

When it is determined that the time data is stored in the storage unit 500, the controller 400 determines whether the temperature of the refrigerator detected by the temperature detection unit 300 exceeds a reference time (704). During operation of the refrigerator, temperature in the refrigerator is maintained at approximately −2° C. to 0° C. When the refrigerator is stopped, temperature in the refrigerator increases as time passes. For example, when temperature in the refrigerator exceeds approximately 8° C. after time passes, it may be determined that the refrigerator is stopped. That is, when the temperature of the refrigerator exceeding approximately 8° C. is detected by the temperature detection unit 300, it may be determined that much time has elapsed based on the time data stored in the storage unit 500.

On the other hand, when the temperature of the refrigerator is below 8° C., it may be determined that it is sufficient to confirm a season although time has elapsed after the refrigerator is stopped. Consequently, a season may be decided based on the time data stored in the storage unit 500.

When the temperature of the refrigerator exceeds the reference temperature, which means that time has elapsed to the extent that the time data stored in the storage unit 500 may not be used to confirm a season, the controller 400 requests the external source, such as the user, to input new time data (714). When the temperature of the refrigerator exceeds the reference temperature, the time data stored in the storage unit 500 may not correctly reflect the current season. Consequently, the external source, such as the user, may be requested to input new time data (714). In this case, the time data may blink as shown in FIGS. 2A to 2C.

The time data is input to determine a season in which food is stored and to decide food storage conditions based on the determined season. For example, for Kimchi, a season corresponding to input date is determined, and a ripening degree and storage conditions are decided and stored based on the determined season. Since Kimchi has different moisture contents and fibroid material properties depending upon season, storage temperature is changed based thereupon. Kimchi may be largely classified into seasonal Kimchi and winter Kimchi. Winter Kimchi has high salinity for long term storage. Consequently, a storage temperature of winter Kimchi may be low. On the other hand, seasonal Kimchi has different moisture contents and fibroid material properties depending upon a point of time when Chinese cabbages are grown, and therefore, a storage temperature of seasonal Kimchi is adjusted based thereupon. Such difference has a greater influence when a storage temperature is controlled than when a ripening temperature is controlled. When Kimchi is ripened and stored, a state of Kimchi is reflected based on season and a storage temperature is changed to increase or decrease a storage period. Also, Kimchi has a low moisture content in winter and a high moisture content in summer. Since Kimchi has high moisture content in summer, Kimchi may be frozen if Kimchi is stored at too low a temperature. Consequently, a storage temperature of Kimchi is decided in consideration of the above conditions.

Subsequently, it is determined whether user input has been performed (730).

When it is determined that the user input has been performed, time data input by the user as shown in FIGS. 2A to 2C is decided as reference time data (733).

When it is determined that the user input has not been performed, default time data stored in the storage unit 500 is decided as the reference time data (736). The default time data may be a standard storage temperature of conventional refrigerators, i.e. a temperature of approximately −2° C. to 0° C. The default time data may be initial time data.

When the temperature of the refrigerator is less than the reference temperature, the time data stored in the storage unit 500 is decided as the reference time data. This means that the current season may be confirmed based on the time data stored in the storage unit 500 and, even when the refrigerator is stopped and a predetermined time has elapsed, the elapsed time does not exceed an error range necessary to confirm the current season as compared with the time data stored in the storage unit 500. Consequently, the time data stored in the storage unit 500 may be decided as the reference time data (724).

Subsequently, a season corresponding to the reference time data is confirmed, and the refrigerator is controlled based on the confirmed season (750). For example, when the decided reference time data is March 15, food is stored at a storage temperature stored in the storage unit 500 corresponding to spring.

Controlling the storage temperature of the refrigerator based on time data indicating season (750) may be performed as follows.

For Korea, seasons may include spring, summer, autumn and winter. For other countries, season may be divided based on average seasonal temperatures and rainfall. Temperature control based on season is set to correspond to four seasons in Korea. Temperature may be controlled based on new temperature distribution in consideration of annual average temperature distribution based on the passage of time. Also, a database of new temperature distributions based on seasonal distributions of other countries may be stored in the storage unit 500 so that temperature is controlled based thereupon.

In summer, temperatures of the refrigerator at an ON value and OFF value are set to be lower than those at an average ON value and OFF value. Since moisture content is high, however, temperature is set so that food is not frozen. In winter, temperatures of the refrigerator at an ON value and OFF value are set to be higher than those at an average ON value and OFF value.

In Korea, for example, it is determined whether the current date is spring (approximately February 16 to June 20) since Korea has four seasons. If the current date is May 10, which is in the spring, control temperature in the refrigerator is set to a range of approximately −2° C. to 1° C., and the compressor 30, as the cooling apparatus, and the heater 50, as the heating apparatus, are controlled to maintain temperature in the refrigerator at the newly set temperature range.

If the current date is July 10, which is in the summer (approximately June 21 to August 31), control temperature in the refrigerator is set to a range of approximately −3° C. to 1° C., and the compressor 30, as the cooling apparatus, and the heater 50, as the heating apparatus, are controlled to maintain temperature in the refrigerator at the newly set temperature range.

If the current date is September 15, which is in autumn (approximately September 1 to October 31), control temperature in the refrigerator is set to a range of approximately −2° C. to 0° C., and the compressor 30, as the cooling apparatus, and the heater 50, as the heating apparatus, are controlled to maintain temperature in the refrigerator at the newly set temperature range.

If the current date is December 25, which is in winter (approximately November 1 to February 15), control temperature in the refrigerator is set to a range of approximately −1° C. to 1° C., and the compressor 30, as the cooling apparatus, and the heater 50, as the heating apparatus, are controlled to maintain the temperature of the refrigerator at the newly set temperature range.

In the season confirmation process according to the embodiment and the temperature control process based thereupon, time data is input by a user when the refrigerator is turned on, the controller 400 continuously counts time, a season is confirmed based on a point of time when a function of the refrigerator is selected by the user, and the storage temperature is controlled based on the properties of food (Kimchi) based on the season. That is, when the refrigerator is initially operated, previously stored time data or new time data input by the user is decided as the reference time data, and the decided time data is continuously counted. Subsequently, a point of time when food (Kimchi) is placed in the refrigerator and a function of the refrigerator is set by the user is confirmed as a season in which the food (Kimchi) is stored, and storage temperature of the refrigerator is controlled in consideration of the properties of the food (Kimchi) corresponding to the confirmed season.

Alternatively, the controller 400 may request the user to input time data at a point of time when food (Kimchi) is placed in the refrigerator and a function of the refrigerator is selected by the user, a point of time when the function of the refrigerator is selected may be confirmed as a season in which the food (Kimchi) has been prepared, and storage temperature may be controlled based thereupon. Also, a seasonal Kimchi selection button and a winter Kimchi selection button may be separately provided so that Kimchi may be stored in a state desired by the user without additional input of time data. Consequently, a ripening or storage function may be changed based on kinds of Kimchi (winter Kimchi and seasonal Kimchi) and a Kimchi storage period may be increased.

As is apparent from the above description, storage conditions may be controlled based on the properties of food based on season according to the embodiment, thereby improving preservation efficiency of food. Especially for Kimchi, a Kimchi storage period may be increased according to distinctions of a ripening or storage function based on kinds of Kimchi (winter Kimchi and seasonal Kimchi).

The operating method of the processor according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Any one or more of the software modules described herein may be executed by a dedicated processor unique to that unit or by a processor common to one or more of the modules. The described methods may be executed on a general purpose computer or processor or may be executed on a particular machine such as the processor supporting a method for controlling a refrigerator described herein.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A control method of a refrigerator, comprising:
determining whether time data to be used to confirm a season is stored in a storage unit;
requesting input of time data upon determining that the time data is not stored in the storage unit; and
determining whether the stored time data is to be changed upon determining that the time data is stored in the storage unit.

2. The control method according to claim 1, wherein requesting the input of time data comprises requesting a user to input time data through display on a display unit or sound.

3. The control method according to claim 1, further comprising deciding the input time data as reference time data when the time data is input by a user.

4. The control method according to claim 1, further comprising deciding default time data as reference time data after a predetermined time elapses when the time data is not input by a user.

5. The control method according to claim 1, further comprising comparing temperature in the refrigerator with a reference temperature to decide reference time data when the time data is stored in the storage unit.

6. The control method according to claim 5, further comprising requesting a user to input time data when the temperature in the refrigerator is equal to or greater than the reference temperature.

7. The control method according to claim 6, further comprising deciding the input time data as the reference time data when the time data is input by the user.

8. The control method according to claim 5, further comprising deciding time data stored in the storage unit as the reference time data when the temperature in the refrigerator is less than the reference temperature.

9. The control method according to claim 3, further comprising confirming a season based on the decided reference time data.

10. The control method according to claim 9, further comprising controlling the refrigerator based on the decided reference time data, wherein controlling the refrigerator based on the decided reference time data comprises controlling storage temperature in the refrigerator.

11. The control method according to claim 5, wherein comparing the temperature in the refrigerator with the reference temperature to decide the reference time data comprises determining whether the time data stored in the storage unit corresponds to a season.

12. The control method according to claim 1, wherein the storage unit stores a database of food storage temperatures based on the time data to be used to confirm the season.

13. The control method according to claim 1, wherein the time data to be used to confirm the season comprises months, months and days, or years, months and days.

14. A refrigerator comprising:
a storage unit to store time data to be used to confirm a season; and
a controller to request a user to input time data upon determining that the time data is not stored in the storage unit and to determine whether the stored time data is to be changed upon determining that the time data is stored in the storage unit.

15. The refrigerator according to claim 14, further comprising a display unit to indicate whether the time data is stored in the storage unit and to display the time data.

16. The refrigerator according to claim 15, wherein the display unit displays the time data in seven segments.

17. The refrigerator according to claim 14, further comprising a manipulation unit to allow a user to input the time data.

18. The refrigerator according to claim 14, wherein the storage unit stores a database of food storage temperatures based on the time data to be used to confirm the season.

19. A non-transitory computer-readable recording medium having embodied thereon a program instructing a computer to execute the method of claim 1.

20. A refrigerator comprising:
a storage unit to store time data;
a controller to control operation of the refrigerator based upon the time data and, wherein the controller controls a temperature of the refrigerator based upon the time data,
wherein the controller controls the operation of the refrigerator to maintain the temperature for a period of time based upon the time data.
